(19) United States
(12) Patent Application Publication
(10) Pub. No.: US 2011/0127179 A1
(43) Pub. Date: Jun. 2, 2011

(54) DENTAL APPLIANCE CLEANSER

(76) Inventor: Joseph Hyungkook Ahn, Parsippany, NJ (US)

(21) Appl. No.: 12/664,700

(22) PCT Filed: Jun. 18, 2008
(86) PCT No.: PCT/US08/67268

§ 371 Date: Aug. 6, 2010

Related U.S. Application Data
(60) Provisional application No. 60/944,618, filed on Jun. 18, 2007.

(51) Int. Cl. B65D 67/00; C11D 3/37

(52) U.S. Cl. 206/229; 510/117

(57) ABSTRACT

This disclosure relates to a dental appliance cleanser which is a non-effervescent formulation containing a water insoluble polymeric disintegrant.

### BACKGROUND OF THE INVENTION

1. Field of the Invention

This disclosure relates to a dental appliance cleanser which is a non-effervescent formulation containing a water insoluble, water swellable polymeric disintegrant. The cleanser is used to clean dental appliances in a water bath heated to a temperature between 55 and 70° C.

2. Description of the Related Art

Full or partial dentures are intended to be worn in the mouth to replace missing teeth. Like teeth, dentures and other dental appliances should be cleaned regularly to maintain good oral health. Like teeth, dental appliances should also be cleaned regularly for cosmetic reasons, for example to maintain fresh breath. It is well known that microbiological deposition and proliferation on dentures and other dental appliances causes a number of problems for patients and their treating dentists. Such problems include odor, denture-induced stomatitis, staining and an unpleasant taste to the appliance as well as within the oral cavity.

Unlike teeth, dentures and other dental appliances can be removed for cleaning. Dental appliances are also made of durable materials, such as acrylic polymers, that can withstand relatively harsh cleaning conditions. As a result, they can be, and sometimes are, exposed to harsh cleaning conditions. They are typically cleaned in one of two ways, either they are soaked for some time in a cleansing bath or they are brushed with dentifrices or specially formulated cleansing creams.

Brushing with creams has the advantage of supplementing the cleaning formulation with mechanical action. Unfortunately, as with teeth, spots on the dental appliances can be missed or overlooked during the brushing process. As a result, the material of the dental appliance can degrade over time, and remaining teeth and gums of the user may be exposed to disease agents and undesirable cosmetic consequences.

Soaking in a cleansing bath offers the advantage of reaching every part of a denture for cleaning. Full immersion of the denture in the bath allows the cleansing composition to reach surface areas that can not be reached by ordinary brushing with creams. Cleansing baths are not usually sold as such. Typically, the active ingredients are sold in solid form, as a denture cleanser powder or tablet, or in concentrated liquid form. The active ingredients are then dissolved in a water bath to form the cleansing bath.

While badly stained dentures or those with significant bacterial contamination require long-term (e.g., overnight) soaking, patients often object to being without their prostheses for extended periods. In addition, soaking surrenders the advantage of mechanical scrubbing found with creams and dentifrices. To compensate for this loss of mechanical cleaning, denture cleansing tablets and powders usually contain an effervescent system to mimic mechanical scrubbing and strong chemical cleaning agents. However, cleansing is an even greater problem with older appliances since these may have deep stains, as well as bacterial contamination, that have progressed into the bulk material of the appliance material. In such cases, soaking the appliance in effervescent cleansers at room temperature may not achieve the requisite depth of action to achieve complete denture cleansing within the pores and crevices found in dental appliance materials, e.g., acrylic resin.

The use of microwave radiation, alone or in conjunction with effervescent cleansers, has been claimed to be very effective in removing adherent denture plaque. However, the uneven heating resulting from microwave radiation when the dental appliances are immersed in water, could raise the temperature of the acrylic resin above the safe limit of 70-75° C., which is approaching the glass transition temperature of acrylic resin. Therefore, microwave heating may increase risk of distortion of the denture if the acrylic resin is heated to temperatures above 70° C.

Therefore, there is a need to clean dental appliances deep within the acrylic resin by heating a water bath to a temperature at or below 70° C. in combination with a suitable dental appliance cleanser. Such a dental appliance cleansing formulation should be stable at increased temperatures.

Co-pending application No. 60/936,057 (Attorney Docket No. 0003479USP/2420, filed Jun. 18, 2007) discloses an apparatus for heating dental appliances in water to a sustained temperature between 55 and 70° C. Use of the non-effervescent dental appliance cleansing formulation of this disclosure in an apparatus that maintains the temperature of the water bath between 55 and 70° C. is desired because the active oxygen contained in the formulation is released in a controlled manner and without excessive foaming and bubbling, as would be found if an effervescent tablet were to be used. In addition, the combination of active oxygen and heat is advantageous to cleaning within the pores and crevices of the dental appliance.

### SUMMARY OF THE INVENTION

In one aspect, this disclosure relates to a dental appliance cleansing formulation comprising at least one oxidizing agent and a crosslinked polymeric disintegrant, wherein the formulation is non-effervescent.

In a further aspect, this disclosure relates to a dental appliance cleansing formulation comprising at least one oxidizing agent and a crosslinked polymeric disintegrant, wherein the formulation is non-effervescent and wherein the oxidizing agent is released over an extended period of time in an aqueous environment.

In another aspect, this disclosure relates to a method of cleansing a dental appliance outside the oral cavity comprising maintaining the dental appliance in contact with a dental appliance cleansing formulation comprising at least one oxidizing agent and a crosslinked polymeric disintegrant, wherein the formulation is non-effervescent, for a time sufficient to clean the dental appliance and rinsing the dental appliance with water.

In still another aspect, this disclosure relates to a method of cleansing a dental appliance outside the oral cavity comprising maintaining the dental appliance in contact with a dental appliance cleansing formulation comprising at least one oxidizing agent and a crosslinked polymeric disintegrant, wherein the formulation is non-effervescent, at elevated temperatures and for a time sufficient to clean the dental appliance and rinsing the dental appliance with water.

In yet another aspect, this disclosure relates to a kit for delivering a dental appliance cleansing formulation comprising at least one oxidizing agent and a crosslinked polymeric disintegrant, wherein the formulation is non-effervescent, the kit comprising a dispenser capable of dispensing the cleansing formulation and a separately packaged water bath apparatus capable of maintaining a sustained temperature in a range between 55 and 70° C. In still yet another aspect, this disclosure relates to a method for maintaining prolonged fresh breath in the mouth of a dental appliance wearer by cleansing the dental appliance with a dental appliance cleansing formulation comprising at least one oxidizing agent and a crosslinked polymeric disintegrant, wherein the formulation is non-effervescent, said cleansing comprising maintaining the dental appliance in contact with the dental appliance cleansing formulation for a time sufficient to maintain prolonged fresh breath, rinsing the dental appliance with water and placing the dental appliance in the mouth of the wearer.

In yet another aspect, this disclosure relates to a dental appliance cleansing formulation comprising at least one oxidizing agent and a crosslinked polymeric disintegrant, wherein the formulation is more stable to moisture than conventional dental appliance cleansing effervescent formulations.

### DETAILED DESCRIPTION OF THE INVENTION

The terms “clean”, “cleansing” or “cleaning” are used interchangeably herein to refer to removing food particles, stain and other oral debris, both on the surface and within the pores of a dental appliance, with the formulation disclosed herein.

The term “crosslinked polymeric disintegrant” is used herein to refer to a water insoluble, water swellable agent which aids in the break up of a tablet allowing the release of the active agents.

The term “dental appliance” is used herein to refer to dentures or partial dentures, artificial teeth, removable orthodontic bridges and denture plates, both upper and lower types, orthodontic retainers and appliances, protective mouthguards, nightguards to prevent bruxism and/or Temporomandibular joint (TMJ) disorder, and the like.

The term “denture cleanser” is used herein to refer to a formulation for use outside the mouth to clean dental appliances.

The term “prolonged fresh breath” is used herein to refer to a combination of mouth-feel, denture odor control and mouth odor control sustainable for up to 2 or more hours.

The instant inventive dental appliance cleanser formulation can be made into a powder or tablet, and is particularly useful for formulating tablet cleansers. Furthermore, in one specific embodiment, the tablet is placed in a water bath. In another embodiment, the tablet is placed in a water bath which is heated and maintained at a temperature between 55 and 70° C.

Without being bound to any particular theory, it is believed that a combination of heat with the active oxygen released by the disintegration of the non-effervescent dental appliance cleansing formulation enables a deep cleaning action needed to eliminate build-up on surfaces and inside pores and grooves found in many dental appliances. Particularly, this is achieved by dissolving the dental appliance cleansing formulation in the heated liquid that is maintained at the optimal cleaning temperature and/or range for a minimum of two minutes. In one embodiment, disintegration occurs over the course of two to ten minutes. In a second embodiment, disintegration occurs over the course of three to eight minutes. In a third embodiment, disintegration occurs over the course of five minutes.

The optimal temperature range is intended to accentuate the cleaning effectiveness of the instant cleansing formulation, without damaging the material from which the dental appliance is made. Depending on the item that is to be cleaned, the optimal temperature range is 55 to 70° C. In one embodiment, the water is heated to a temperature range between 60 and 68° C. In a second embodiment, the water is heated to a temperature range between 60 and 65° C. The temperatures disclosed herein may vary +/−1 degree Celsius.

The dental appliance cleanser formulation utilizes at least one oxidizing agent and a crosslinked polymeric disintegrant. The oxidizing agent provides the source for active oxygen needed during the cleaning process. The disintegrant provides for the breaking apart of the tablet which disintegrates over time, slowly releasing the oxidizing agent during the cleaning process. Suitably, the formulation is used in combination with a water bath heated to the optimal temperature range. Since an effervescent system is not used in the disclosed formulation, this creates a cleaner water bath with fewer bubbles. In addition, without an effervescent system, production of a much smaller tablet compared with conventional denture cleansing tablets using effervescent systems, is enabled, without sacrificing cleansing efficacy. Further, the instant non-effervescent tablet is more stable and less sensitive to moisture conditions than conventional effervescent tablets.

Suitable oxidizing agents for use in this disclosure include, but are not limited to, persalt agents such as alkali metal and ammonium persulfates, perborates, percarbonates and perphosphonates; and the alkali metal and alkaline earth metal peroxides, or a combination thereof. Examples of suitable agents include potassium, ammonium, sodium and lithium persulfates and perborate mono- and tetrahydrates; sodium pyrophosphate peroxyhydrate; and magnesium, calcium, strontium and zinc peroxides, or a combination thereof. In one embodiment, a persulfate and a perborate are used in combination. In a second embodiment, a monopersulfate and a perborate are used in combination. In yet another embodiment, an alkali metal monopersulfate and a perborate are used in combination. In still yet another embodiment, potassium monopersulfate and an alkali metal perborate are used in combination. In yet a further embodiment, potassium monopersulfate and sodium perborate are used in combination.

The oxidizing agent is contained in the formulation in an amount between 50 and 70 percent weight/weight (“% w/w). In one embodiment, there is a combination of persulfate and perborate oxidizing agents. In this embodiment, the persulfate oxidizing agent is contained in the formulation in an amount between 20 and 30% w/w of the total composition, and the perborate oxidizing agent is contained in the formulation in an amount between 30 and 40% w/w of the total composition.

The oxidizing agents, in particular potassium monopersulfate, are available from DuPont located in Wilmington, Del., USA.

Suitable disintegrants for use in this disclosure include, but are not limited to, polyvinylpolypyrrolidone (available commercially as POLYCLAR or POLYPLASDONE, from International Specialty Products, Wayne, N.J., USA; and as KOLLIDON, CL, from BASF, Florham Park, N.J., USA); cross-linked sodium carboxymethylcellulose (available commercially from FMC BioPolymer, Philadelphia, Pa., USA); and sodium starch glycolate (available commercially from JRS Pharma LP, Patterson, N.Y., USA).

The disintegrant is contained in the formulation in an amount between 1 and 10% w/w of the total composition. In one embodiment, the disintegrant is contained in the formulation in an amount which is 5% w/w of the total composition.

In addition to the oxidizing agent and disintegrant, the formulation may contain one or more excipients suitably found in known dental appliance cleansers, including, but not limited to surfactants, bleach activators, chelating agents, enzymes, flavoring agents, lubricants for tablet processing, antimicrobial compounds, sweeteners, tablet binders and fillers, moisture scavengers, preservatives, and the like.

The formulation may contain one or more surfactants including, but are not limited to, anionic surfactants, zwitterionic surfactants and non-ionic surfactants, or a combination thereof. Suitable anionic surfactants include, but are not limited to, sodium lauryl sulphate and other alkyl sulfates, alkyl ethersulfates, sodium lauryl sulfoacetate, dialkyl sulfosuccinates, alkylbenzene sulfonates, alpha olefin sulfonates, acyl N-methyl taurates and, sodium lauroyl sarcosinate. One embodiment contains sodium lauryl sulfoacetate, in an amount between 4% w/w and 7% w/w.

Suitable non-ionic surfactants include, but are not limited to, polyoxyl hydrogenated castor oil, the ethoxylated sorbitan alkanoates, fatty acid ethoxylates, fatty alcohol ethoxylates, fatty amine ethoxylates, polyethylene oxide/polypropylene oxide block polymers (Pluronics) and sucrose esters.

Suitable zwitterionic surfactants include, but are not limited to, cocamidopropyl betaine and alkyl amidopropyl betaines.

Generally the surfactants disclosed herein are commercially available from Stepan Company, Illinois, USA.

The formulation may contain one or more chelating agents beneficial in aiding cleaning and bleach stability by keeping metal ions, such as calcium, sodium, and heavy metal cations, in solution. Chelating agents, include, but are not limited to, sodium polyphosphate, sodium tripolyphosphate, sodium acid pyrophosphate, tetrasodium pyrophosphate, aminopolycarboxylates such as nitrilotriacetic acid and ethylenediamine tetraacetic acid and salts thereof, and polyphosphonates and aminopolyphosphonates such as ethylenediamine tetramethylenephosphonic acid, diethylenetiraminepentamethylenephosphonic acid and salts thereof, and combinations thereof. The chelating agent is contained in the formulation in an amount between land 20% w/w of the total composition. In one embodiment, the chelating agent is sodium polyphosphate available commercially from Innophos in New Jersey, USA, and is found in an amount between about 10 and 18% w/w of the total composition. In another embodiment, the chelating agent is sodium EDTA available from Dow Chemical Company, Michigan, USA, and is found in an amount between 1 and 5% w/w of the total composition. In yet another embodiment, there is a combination of EDTA and sodium polyphosphate, for a total range of 1-20% w/w of the total composition.

Enzymes suitable for use herein are exemplified by proteases, alkalases, amylases, lipases, dextranases, mutanases, glucanases, and the like.

Flavorants suitable for use in the compositions of the disclosure include, but are not limited to, wintergreen oil, peppermint oil, spearmint oil, lemon, oil, orange oil, anise oil, clove oil, cinnamon leaf oil, or combinations thereof. Flavorants are found in the composition in an amount between 0.0 and 2.5% w/w of the total composition.

Suitable antimicrobial agents for use in this disclosure include, but are not limited to, thymol, menthol, triclosan, phenol, eucalyptol, benzoic acid, 4-hexylresorcinol, methylparaben, propylparaben, salicylamides, sodium benzoate, and combinations thereof. One of skill will recognize that the listed antimicrobial agents may also serve as a preservative in the inventive formulation.

Suitable moisture scavengers for use in this disclosure include, but are not limited to, soda ash available commercially from FMC Industrial Chemicals Group, Philadelphia, Pa., USA.

The compositions according to the present disclosure may be prepared by blending the ingredients, then packaging in a sachet or tabletting in accordance with art recognized procedures.

The dental appliance cleanser formulation can be in the form of a powder, sachet, or tablet. Each solid dosage form may be packaged in a manner conventional in the art. As solid dosage forms, the dental appliance cleansing formulation is placed in water, or other suitable liquid, to form a cleansing composition and to activate the cleansing process. If in a tablet form, the tablet may be packaged as an individual or with other tablets, for example, as in a cartridge as described in co-pending application No. 60/936,057 (Attorney Docket No. Attorney Docket No. 0003479USP/2420, filed Jun. 18, 2007) disclosing an apparatus for heating dental appliances.

Because there is no effervescent system in the formulation of this disclosure, if in tablet form, the tablet is designed to be smaller, and therefore, more easily manufacturable. In addition, without the effervescent system, the tablet has a longer shelf-life and increased stability since it is not unstable in a moisture rich environment.

Suitably, the tablet weighs between 0.7 and 1.4 grams.

Suitably, the tablet has a diameter in a range between 10 and 12 millimeters. In one embodiment, the tablet has a diameter of 11 millimeters.

The instant tablet formulation is designed to be used in a heated liquid bath, for example a heated water bath. Suitable water baths are known in the art. The dental appliance cleanser formulation is placed in the liquid bath and allowed to disintegrate over time. A further advantage of this disclosure is that the dental appliance cleansing formulation is a slow release formulation allowing the oxidizing agent to be released over an extended period of time. After a minimum of 2 minutes, the denture can be rinsed with water and replaced in the mouth. In one embodiment, the water is heated to a temperature between 55 and 70° C. This temperature is maintained for a period between 2 minutes and 10 minutes. In one embodiment, the temperature is maintained for a period between 3 and 8 minutes. In another embodiment, disintegration occurs over the course of 5 minutes. Cleansing is optimized when the water bath is heated so that the active oxygen released from the tablet reaches deep within the pores and grooves found in the material used in making many dental appliances, including denture acrylic.

The disintegration time of a tablet made according to Example 2, at various temperatures, is shown in the table below. Disintegration time was measured by adding one tablet each to 150 mL water at various temperatures, and measuring the time (with a timer) for the tablet to disintegrate. Determination of disintegration of the tablet was based on visual observation. For the 40° C. and 60° C., the water was heated on a hot plate.

| Temperature in Celsius | Disintegration Time |
|---|---|
| 25° C. | 8 min, 30 sec to 8 min, 59 sec |
| 40° C. | 5 min to 5 min, 40 sec |
| 60° C. | 2 min, 30 sec to 3 min |

Dental appliance cleansing formulations falling within the scope of this disclosure are more particularly illustrated in conjunction with the following non-limiting examples.

### EXAMPLES

### Example 1

When making the formulation as disclosed, work should be performed in a well ventilated, dehumidified area. Personal Protective Equipment that should be used including a lab coat, gloves and a respirator.

Into a floor stand Hobart mixing bowl (from Hobart Corporation located in Troy, Ohio), charge all chemical ingredients listed in Examples below one at a time. Fully lower the bowl support of Hobart mixer, then, position the bowl so the ball on the back of the bowl fits in the bowl retainer slot on the bowl support and the alignment pins on the front of the bowl support fit in the holes on the side brackets of the bowl. Lock the bowl in place by rotating the bowl clamps over the side brackets of the bowl. Once completed, install an agitator (“B” flat beater) by placing the agitator in the bowl, pushing it up on the agitator shaft, and turning it clockwise to seat the shaft pin in the slot of the agitator shank. Then raise the bowl, and start the mixer by moving the gear shift lever to the low position. Press the start button. Mix for 10 minutes. Fully lower the bowl, and lift the bowl by releasing the bowl clamps. The resulting mixed powder is then carried to a tablet press room for tabletting. The tablet press (Compacta from SMI located in Lebanon, N.J.) is then fitted with half inch round tablet tools.

Using a sterile disposable scoop, charge final blend into tablet press hopper. Set up the tablet press by compressing tablets (for approximately 30 seconds) to produce product that is within the specification. Stop the press and perform physical tests for weight and hardness. Make any necessary adjustments and repeat the process to obtain a tablet hardness about 10 to 15 Strong-Cobb units and a tablet weight of 1.06 g. Hardness tester can be purchased from Key International, Inc located in Englishtown, N.J.

Collect the tablets in double poly-lined fiber drums with 2 desiccants. (Desiccants added between outer liners and not with product).

### Example 2

The following Tables list the ingredients for suitable formulations falling within the scope of this disclosure.

| Ingredient | % w/w | mg/tab |
|---|---|---|
| Soda Ash, Anhydrous Light | 7.00 | 75.00 |
| Potassium Monopersulfate | 25.67 | 275.00 |
| Sodium Perborate, Monohydrate | 34.08 | 365.13 |
| Sodium Polyphosphate | 15.04 | 161.15 |
| Sodium Benzoate, NF | 2.50 | 26.80 |
| Polyethylene Glycol 8000, NF | 2.50 | 26.80 |
| Sodium Lauryl Sulfoacetate | 4.78 | 51.25 |
| Crosslinked polyvinylpolypyrrolidone | 5.00 | 53.55 |
| EDTA | 2.33 | 25.00 |
| Flavor | 1.10 | 11.75 |
| Total | 100.00 | 1071.43 |

| Ingredient | % w/w | mg/tab |
|---|---|---|
| Sodium Carbonate, Anhydrous | 7.09 | 75.00 |
| Potassium Monopersulfate | 25.98 | 275.00 |
| Sodium Perborate, Monohydrate | 34.50 | 365.13 |
| Sodium Polyphosphate | 15.23 | 161.15 |
| Sodium Benzoate, NF | 2.50 | 26.50 |
| Polyethylene Glycol 8000, NF | 2.50 | 26.50 |
| Sodium Lauryl Sulfoacetate | 4.84 | 51.25 |
| Crosslinked polyvinylpolypyrrolidone | 5.00 | 52.90 |
| EDTA | 2.36 | 25.00 |
| Total | 100.00 | 1058.43 |

The above description fully discloses the invention including preferred embodiments thereof. Modifications and improvements of the embodiments specifically disclosed herein are within the scope of the following claims. Without further elaboration it is believed that one skilled in the art can, given the preceding description, utilize the present invention to its fullest extent. Therefore any examples are to be construed as merely illustrative and not a limitation on the scope of the present invention in any way. The embodiments of the disclosure in which an exclusive property or privilege is claimed are defined as follows.

1. A dental appliance cleansing formulation comprising at least one oxidizing agent and a crosslinked polymeric disintegrant, wherein the formulation is non-effervescent.

2. (canceled)

3. The formulation of claim 1, wherein the oxidizing agent is selected from potassium, ammonium, sodium and lithium persulfates and perborate mono- and tetrahydrates; sodium pyrophosphate peroxyhydrate; magnesium, calcium, strontium and zinc peroxides; and a combination thereof.

4. (canceled)

5. The formulation of claim 3, wherein the oxidizing agent is a combination of an alkali metal monopersulfate and an alkali metal perborate.

6. The formulation of claim 5, wherein the oxidizing agent is potassium monopersulfate and sodium perborate.

7. A method of cleansing a dental appliance outside the oral cavity comprising maintaining the dental appliance in contact with an aqueous solution comprising a non-effervescent dental appliance cleansing formulation comprising at least one oxidizing agent and a crosslinked polymeric disintegrant.

8. The method of claim 7, further comprising the step of heating the aqueous solution to a temperature between 55 and 70° C.

9. The method of claim 7, further comprising the step of heating the aqueous solution to a temperature between 60 and 68° C.

10. (canceled)

11. A kit for delivering a dental appliance cleansing formulation comprising at least one oxidizing agent and a crosslinked polymeric disintegrant, wherein the formulation is non-effervescent, the kit comprising a dispenser means for the dental appliance cleansing formulation and a container for holding an aqueous solution of the formulation and the dental appliance in contact with one another.

12. The kit of claim 11, wherein the dispensing means is a blister pack.

13. The kit of claim 11, wherein the container is capable of heating the aqueous solution of the formulation to a temperature between 55 and 70° C.

14. (canceled)

15. The kit of claim 11, wherein the container is capable of heating the aqueous solution of the formulation to a temperature between 60 and 65° C.

16. A dental appliance cleansing formulation comprising at least one oxidizing agent and a crosslinked polymeric disintegrant, wherein the formulation is non-effervescent, and wherein the oxidizing agent is released over an extended period of time in an aqueous environment.

17-18. (canceled)

19. The dental appliance cleansing formulation of claim 16, wherein the oxidizing agent is a combination of a persulfate and a perborate.

20. The dental appliance cleansing formulation of claim 16, wherein the oxidizing agent is potassium monopersulfate and sodium perborate.

21. The dental appliance cleansing formulation of claim 16, wherein the aqueous environment is heated.

22. The dental appliance cleansing formulation of claim 21, wherein the aqueous environment is heated for a time between two and ten minutes.

23. The dental appliance cleansing formulation of claim 22, wherein the aqueous environment is heated for a time of five minutes.

24. The dental appliance cleansing formulation of claim 21, wherein the aqueous environment is heated to a temperature between 55 and 70° C.

25. (canceled)

26. The dental appliance cleansing formulation of claim 21, wherein the aqueous environment is heated to a temperature between 60 and 65° C.
